(19) United States
(12) Patent Application Publication
(10) Pub. No.: US 2009/0318126 A1
(43) Pub. Date: Dec. 24, 2009

(54) ARRANGEMENT FOR USING ERP-SYSTEMS ON, PREFERABLY, MOBILE DEVICES

(76) Inventor: Peter Schimitzek, Geilenkirchen (DE)

Correspondence Address: MICHAEL J. STRIKER, 103 EAST NECK ROAD, HUNTINGTON, NY, 11743, US

(21) Appl. No.: 12/159,443

(22) PCT Filed: Nov. 30, 2006
(86) PCT No.: PCT/DE06/02113

§ 371 Date: Sep. 8, 2008

(30) Foreign Application Priority Data
Dec. 29, 2005 (DE) 20 2005 020 364.5

(51) Int. Cl. H04M 3/00

(52) U.S. Cl. 455/419

(57) ABSTRACT

The invention relates to an arrangement for using, in particular, ERP-applications of different clients in the form of, preferably, any particular mobile terminal, enabling data exchange with internal ERP-systems via the extranet and intranet. A user can select between different applications according to predetermined authorizations, which are not stored on the terminal, which can be initially guided according to the individual selection thereof and enables access to the internal ERP-systems. According to the invention, in a connection (6) between the mobile end terminal (1) to the ERP-system (4) via the intranet (10), a mobile ERP-server (3) having a special memory area (9) is located (6) between the connection (6) and the intranet (10). In said special storage area, configured specific access authorizations to the modules (5) of the ERP-systems (4) are stored for each individual user and for each mobile terminal (1), the logic of said modules taking the form of applications and supplementary applications linked to individually adapted menus (7) with scripts of a mask which is reproduced on a display (8) of the mobile terminal (1).

Arrangement for using ERP-systems on preferably mobile terminals.

The invention relates to an arrangement for using, in particular, ERP-applications by different clients in the form of preferably any mobile terminals, which enables a data exchange with internal ERP-systems via an extranet and intranet, wherein a user can select between different applications according to predetermined authorizations and obtains access to internal ERP-systems.

It is generally common practice to access or call up information such as entries in databases via external and internal networks using mobile terminals.

Solutions are also known in which “pushing” of messages or other information to a terminal of a user takes place. In so doing, data on internal databases can be synchronized with those of the terminal, or mobile access to, for example, data services, appointment schedules, internet or company data may additionally become possible.

From document WO 01/78342 A2 such a system and a method for “pushing” information from a host system to a mobile data terminal are known. After user-defined changes to data have been detected by the host system the user may then place the delivered data in a particular folder of the terminal, or the software on the mobile device automatically synchronizes the respective content of the folders to that of the host system.

A further method and system based on this principle are described in document WO 02/25890 A2 and redirect data from a host system to one or several mobile data communication devices via a wireless packet data network by means of special software. Each user can individually establish which data are redirected to him by the host system after receipt, wherein the mobile terminal periodically contacts a server and then transmits the data intended for the address thereof, or a connection to the mobile terminal is created by the network, which terminal then contacts the data network and obtains a network address, and the server subsequently sends the readdressed data to the mobile device.

Solutions of this type generally require special mobile terminals with software adapted thereto.

Large storage capacities are required for the software of the device and of the application and transmitted data.

Apart from the transmission of data and the calling up of information from databases there is no possibility of initiating, from the mobile terminal, the generation of data of individual requests on a host system via networks and of transmitting essentially only the results thereof to the mobile terminal.

The object of the invention is to develop an arrangement for using, in particular, ERP-applications by different clients in the form of preferably any mobile terminals, which enables a data exchange with internal ERP-systems via an extranet and intranet, wherein, according to predetermined authorizations, a user can select between different applications which are not stored on his terminal, which can be executed only after individual selection thereof and permits access to internal ERP-systems.

The object is achieved by the features mentioned in claim 1. Preferred developments are given in the subordinate claims.

An arrangement for mobile use of an ERP-system (Enterprise Resource Planning system), in particular for CRM (Customer Relationship Management), consists essentially of a mobile ERP-server, which enables access to, and communication between, any terminals as clients, preferably mobile terminals via an extranet with an intranet, comprising an ERP-system with a number of mobiles. Clients can be in particular mobile telephones, pocket PCs, other suitable mobile terminals and also terminals with Web applications, which create a connection to the mobile ERP-server wirelessly or in a wired manner via access points and networks such as the internet, telephone networks or mobile telephony networks.

One particular embodiment is formed by the arrangement with an external ERP-system which is connected via the extranet, the mobile ERP-server to the ERP-systems in the intranet, wherein the data exchange between the ERP-systems takes place via a tunneled VPN (Virtual Private Network), for example via the internet. In this way data stocks on line can be mirrored or matched between different systems with different program versions on line, such as between the ERP-system at the headquarters of a company and that of its remote subsidiary.

The user creates with his (mobile) terminal a connection to a server and logs onto it. After this logging-in process on a mobile ERP-server, a menu with a number of selectable applications in the form of scripts for use of ERP-logic on a company server is transmitted to the user's terminal and represented on a display.

The individual modules of the ERP-logic are encapsulated.

The user selects a script from the menu, this selection is sent to the mobile ERP-server. From the server the script for the selected application is transmitted to the terminal and executed, and, by means thereof, the user can use the ERP-logic on the server.

Thus, for example, from the user's location it is possible to initiate tasks relating to the evaluation of debit and credit accounts, goods management concerning deliveries and services, transport planning and appointment scheduling, telephone management or event management.

Then, corresponding to the request of the user to the module(s) of the ERP-system, only field contents of the result of the request are transmitted to the terminal and represented on the display of the terminal.

For each user/terminal, specific access authorizations to individual modules of the ERP-system and specific individually adapted menus with scripts for the masks to be shown and the rights of the individually usable applications are placed, amongst other things, as containers on the server.

N-dimensional representation and characterizing possibilities of a piece of software result from this and are adapted in a user-specific and device-specific way.

From the server the information is always received by the terminal in an active manner.

The advantages of the invention are, in particular, in the small storage capacity required for the scripts on the mobile terminals, the fact that they do not have to be updated since they are always transmitted in the current version and therefore the current ERP-logic is always used as applications on the server to generate the data for the result of a request and data input into the system.

The use of standard interfaces between the networks also has an advantageous effect so that any terminal of an authorized user can use the ERP-logic and further in-house applications, wherein this is independent of the operating system and conventional security techniques are included such as for authentication and data transmission.

A further security effect results from the fact that no applications and result data are stored on the mobile terminals so that if a device is lost no misuse is possible through access to in-house data by third parties.

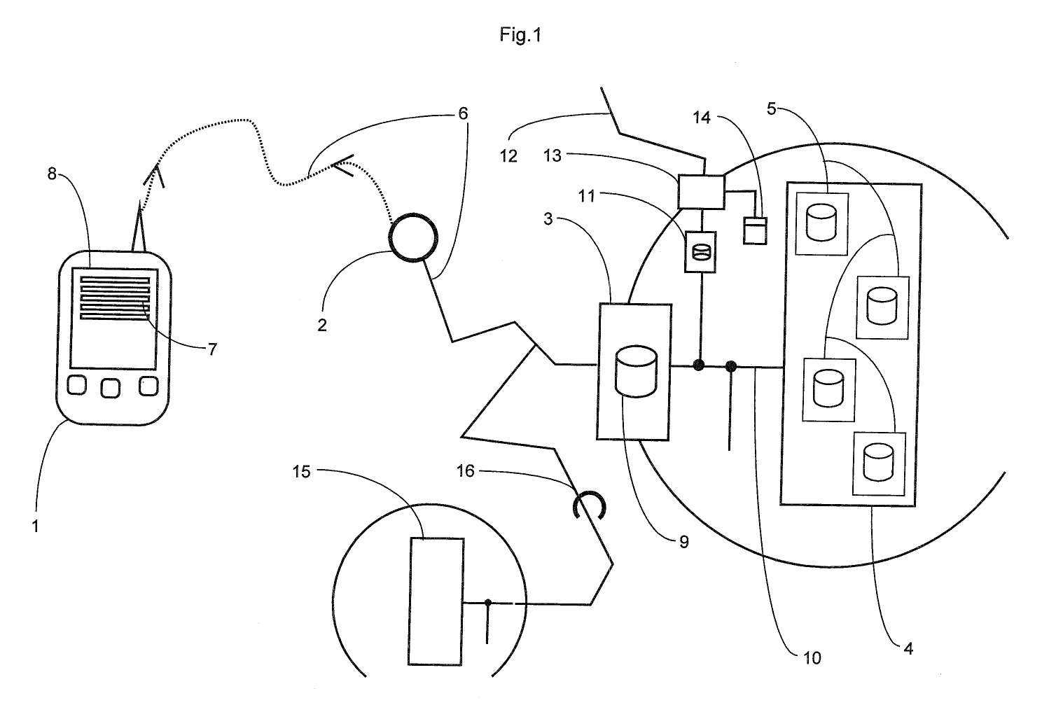

The invention is explained in more detail as an exemplified embodiment with the aid of FIG. 1 which shows a schematic illustration of an arrangement for using ERP-systems by means of a mobile terminal.

An arrangement for preferably mobile use of an ERP-system and further applications essentially comprises a mobile terminal 1 suitable for the data exchange, a conventional access point 2, a mobile ERP-server 3 and an ERP-system 4 with ERP-logic in the form of modules 5. In order to use and execute applications from the area of the ERP and in-house management, the user creates a connection 6 to the mobile ERP-server 3 with his mobile terminal 1 via the access point 2 and logs on with his personal identification. After authentication, a script is transmitted to the mobile terminal 1 from the mobile ERP-server 3 via the connection 6, a wireless and/or wire-bound extranet, this script serves to reproduce a mask with a menu 7 on a display 8 with a number of applications which can be used specifically by the user, wherein the script for each selectable application in the menu 7 contains a command line with which the transmission of scripts for starting applications, such as modules 5 of the ERP-system 4, to the mobile terminal 1 from the mobile ERP-server 3 can be initiated.

The quantity and type of applications usable by the user is dependent on individually configured authorizations as well as on the technical features of the mobile terminal 1.

Stored as containers on the mobile ERP-server 3 in a special memory region 9 are specific authorizations, which are configured individually for each user and for each mobile terminal 1, for access to the modules 5 of the ERP-system 4 and further applications in conjunction with the resulting individually adapted menus 7 with the scripts for the masks to be displayed on the display 8 of the mobile terminal 1, the associated command lines for calling up applications and the rights of the respective accessible applications of modules 4.

After the user selects an application offered in the menu 7 the corresponding command line of the script is transmitted from the mobile terminal 1 to the mobile ERP-server 3 from where the mobile terminal 1 obtains a script for use of the logic of one or more modules 5 of the ERP-system 4 as a reply. The display 8 illustrates the mask required for use of the selected application. In a known manner the user inputs into this mask the necessary data, such as addresses, articles and conditions, in order to generate an evaluation or detection of orders for a specific customer.

With the inputs confirmed, the mobile terminal 1 transmits these data and a command for processing the data to the mobile ERP-server 3 which transfers them via an intranet 10 such as a LAN to the application of the ERP-logic of the corresponding mobile 5 of the ERP-system 4. The data generated by the ERP-logic as a result of the data processing are transmitted via the mobile ERP-server 3 and the connection 6 to the mobile terminal 1 and shown as result lines on the display 8.

There is also the option of outputting the result as a hard copy if a printer is connected to the mobile terminal 1.

After implementation of a first script for applications, the remaining scripts can be selected and initiated.

The script for the selection of the applications in the mask of the menu 7 can possibly be stored on the mobile terminal 1. When the mobile terminal 1 makes connection with the mobile ERP-server 3 then a check is always made as to whether a new version is available, which is then transmitted, the old script is not updated but rather replaced.

Therefore the user has de facto a mobile ERP-system 4 on his mobile terminal 1, with which, in particular, tasks in the area of CRM can be processed rapidly and reliably.

Furthermore, when there is an existing connection to the mobile ERP-server 3 the user has the option of accessing data of an event and phone management server 11 via the intranet 10, which server manages, amongst other things, messages which have come in for him at a workstation 14 in his company from a public network 12 via a telephone system 13 and/or other networks. These messages can be called up, forwarded and processed by the mobile terminal 1. Similarly, call diversions and appointment scheduling, for example, can be carried out from wherever the user is currently located by means of his mobile terminal 1.

The described arrangement and its function are not limited to mobile terminals 1. The mobile terminal 1 is also to be understood as a mobile client.

A user can use conventional internet access via a computer, wherein an internet browser adopts the function of the mobile client with basically equivalent functions.

In addition to the functions of a mobile ERP-system 4 special features of an on line shop can be achieved. Thus by means of a command line it is possible to check on line whether an article is available, the article can be ordered and reserved in stock, wherein there is no coupling via the order processing of the ERP-system, the reserved article is no longer shown to other users as being in stock.

In a further embodiment of the arrangement for use of ERP-systems an external ERP-system 15 is connected to the ERP-system 4 via a VPN 16 in a public network such as the internet, the mobile ERP-server 3 and the intranet 10. In this way the data exchange takes place safely. Data stocks at different locations can therefore be mirrored on line on mutually different systems. On the mobile ERP-server 3 apart from components for authentication of the users and devices conventional security routines to defend against risks and for encryption are implemented.

The user can also obtain access to the data of the external ERP-system 15 in that they are called up via the ERP-system 4.

### REFERENCE NUMERALS USED

1 mobile terminal
2 access point
3 mobile ERP-server
4 ERP-system
5 modules
6 connection
7 menu
8 display
9 special memory region
10 intranet
11 event and phone management server
12 public network
13 telephone system
14 workstation
15 external ERP-system
16 VPN (Virtual Private Network)

1. Arrangement for preferably mobile use of an ERP-system and further applications by users, essentially comprising a mobile terminal suitable for the data exchange, a conventional access point, an ERP-system with ERP-logic as applications in the form of modules, which are connected via extranet and intranet, characterized in that
in a connection (6) from the mobile terminal (1) to the ERP-system (4) via the intranet (10) between the connection (6) and the intranet (10) a mobile ERP-server (3) with a special memory region (9) is disposed, and in the special memory region (9) are stored specific authorizations, which are configured individually for each user and for each mobile terminal (1), for access to the modules (5) of the ERP-system (4), with their logic as applications and further applications linked with individually adapted menus (7) with scripts of a mask displayed on a display (8) of the mobile terminal (1).

2. Arrangement for preferably mobile use of an ERP-system and further applications as claimed in claim 1, characterized in that on the display (8) of the mobile terminal (1) the input mask of an application from the modules (5) of the ERP-system (4) is displayed after, with the selection of an application offered in the menu (7), the associated command line of the script is transmitted to the mobile ERP-server (3) and from there the script for the application is received and stored as a reply.

3. Arrangement for preferably mobile use of an ERP-system and further applications as claimed in claim 1, characterized in that the data input into the mask of the application by the user as a result of the processing are represented as result lines on the display (8) by the ERP-logic-retrieved generated data.

4. Arrangement for preferably mobile use of an ERP-system and further applications as claimed in claim 1, characterized in that the script for selection of the applications in the mask of the menu 7 is stored on the mobile terminal 1.

5. Arrangement for preferably mobile use of an ERP-system and further applications as claimed in claim 1, characterized in that after the mobile terminal 1 has been connected with the mobile ERP-server 3, if a new version of the script for the menu (7) for selection of an application is present, no update of the stored script takes place but after replacement of the script the menu (7) is shown in an updated form.

6. Arrangement for preferably mobile use of an ERP-system and further applications as claimed in claim 1, characterized in that via the ERP-system (4) and a VPN (16) and the mobile ERP-server (3) data called up from an external ERP-system (15) are present on the mobile terminal (1) and are displayed on the display (8).

7. Arrangement for preferably mobile use of an ERP-system and further applications as claimed in claim 1, characterized in that on the mobile ERP-server 3 the access to data of an event and phone management server 11 is implemented via the intranet 10 from the mobile terminal (1).

8. Arrangement for preferably mobile use of an ERP-system and further applications as claimed in claim 1, characterized in that the mobile terminal (1) of a mobile client is in the form of an internet browser on a computer with internet access.
